(19) United States
(12) Patent Application Publication
(10) Pub. No.: US 2023/0065395 A1
(43) Pub. Date: Mar. 2, 2023

(54) COMMAND RETRIEVAL AND ISSUANCE POLICY

(71) Applicant: Micron Technology, Inc., Boise, ID (US)

(72) Inventors: Robert M. Walker, Raleigh, NC (US); Kirthi Ravindra Kulkarni, San Jose, CA (US); Dhawal Bavishi, San Jose, CA (US); Laurent Isenegger, Morgan Hill, CA (US)

(21) Appl. No.: 17/461,502

(22) Filed: Aug. 30, 2021

(51) Int. Cl. G06F 3/06

(52) U.S. Cl. CPC G06F 3/0659; G06F 3/0604; G06F 3/0673

(57) ABSTRACT

A method includes enqueuing host commands of a first type and a second type in a command queue of a host memory controller and preventing a subsequent host command of the first type from being inserted into the command queue responsive to determining that a quantity of host commands of the first type and enqueued in the command queue having met a criterion.

### TECHNICAL FIELD

Embodiments of the disclosure relate generally to memory sub-systems, and more specifically, relate to host command retrieval and issuance policy.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 illustrates an example of operating a command queue in accordance with some embodiments of the present disclosure.

FIG. 3 illustrates another example of operating a command queue in accordance with some embodiments of the present disclosure.

FIG. 4 is a flow diagram corresponding to a method for host command retrieval and issuance policy in accordance with some embodiments of the present disclosure.

FIG. 5 is a block diagram of an example computer system in which embodiments of the present disclosure may operate.

### DETAILED DESCRIPTION

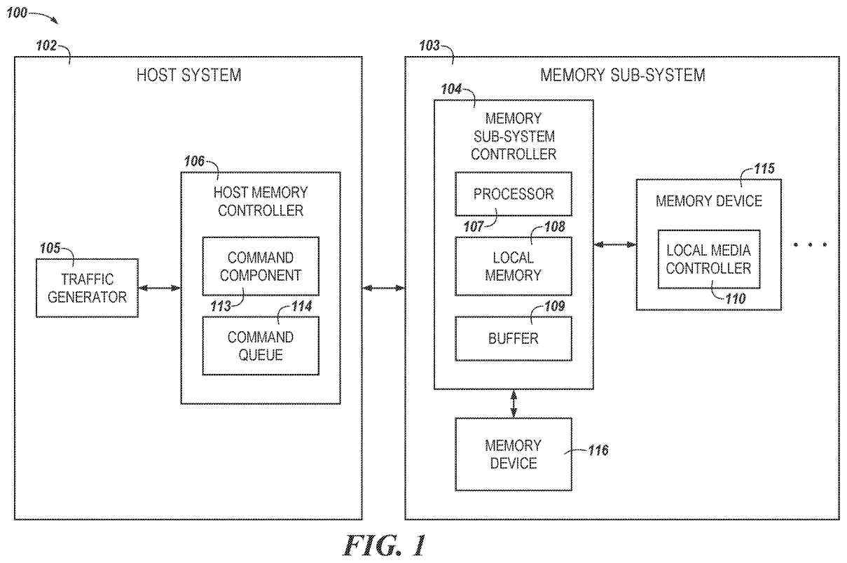

Aspects of the present disclosure are directed to command retrieval and issuance policy, in particular to host systems that include a command component to operate a command queue according to various command retrieval and insertion policies. A memory sub-system can be a storage system, storage device, a memory module, or a combination of such. Example memory modules include dynamic random access memory (DRAM) modules such as dual in-line memory modules (DIMMs) that can support a compute express link (CXL) interconnect standard. An example of a memory sub-system is a storage system such as a solid-state drive (SSD). Examples of storage devices and memory modules are described below in conjunction with FIG. 1, et alibi. In general, a host system can utilize a memory sub-system that includes one or more components, such as memory devices that store data. The host system can provide data to be stored at the memory sub-system and can command data to be retrieved from the memory sub-system.

The host system or an interconnect controller can often include a buffer (e.g., queue) that temporarily store commands (e.g., read or write commands) prior to the commands being issued (e.g., outputted from the host buffer) to the memory sub-system. In some previous approaches, the buffer can operate according to a FIFO (first-in, first-out) policy, which cause the buffer to output commands in an order in which they were received at the buffer. Since the buffer operating according to the FIFO policy does not selectively choose which command(s) to output, the buffer can have significant drawbacks when at least a particular quantity of commands of a particular type and in the buffer is desired to be ensured and/or a command having a particular type and/or particular characteristics is desired to be provided priority when being outputted from the buffer. For example, the memory sub-system can be a write-intensive system, in which a portion of host commands issued to, and executed at, the memory sub-system are primarily write commands as opposed to read commands. Further, a memory sub-system write latency (e.g., latency associated with executing a write command at the memory sub-system) can be significantly higher than a memory sub-system read latency (e.g., latency associated with executing a read command at the memory sub-system) as the write command typically involves in updating any error correction code (ECC) data to conform to host data (e.g., data received from the host system and corresponding to the write command). Accordingly, a host read latency (e.g., latency in receiving a response to a read command once the read command is received at the host system and inserted into the buffer) can be undesirably significant despite execution of a read command exhausting fewer resources of the memory sub-system compared to that of a write command.

Aspects of the present disclosure address the above and other deficiencies by providing a command retrieval and issuance policy that can restrict a quantity of write commands in a command queue to ensure at least a portion of the command queue is reserved for commands of a particular type, such as those commands of a particular type that are desired to be executed more frequently than the other host commands of a different type. The embodiments of the present disclosure can allow retrieval of commands (herein also referred to as host commands or access requests) from a host processing device and/or a host buffer of the host system to insert the retrieved commands into the command queue regardless of whether the commands are of a read or a write command. However, once a particular criterion (e.g., threshold quantity) has been met/reached for a quantity of host commands of a particular type (e.g., write commands) in the command queue, the embodiments of the present disclosure can stop retrieving write commands and allow retrieval of only host commands of a different type (e.g., read commands) to ensure at least a portion of the command queue to be reserved for read commands. Further, read commands in the queue can be provided priority over write commands in the command queue to selectively cause the read commands to be issued to and executed at the memory sub-system prior to at least a portion of the write commands regardless of an order in which those read/write commands were inserted into the queue. In this manner, the embodiments of the present disclosure can avoid a number of read commands being stacked within the command queue despite the number of read requests being executed quickly compared to write commands. Therefore, the embodiments of the present disclosure can improve overall system performance and reduce latency (e.g., a read latency) associated with processing commands in the command queue.

FIG. 1 illustrates an example computing system 100 that includes a memory sub-system 103 in accordance with some embodiments of the present disclosure. The memory sub-system 103 can include media, such as one or more volatile memory devices (e.g., memory device 116), one or more non-volatile memory devices (e.g., memory device 115), or a combination of such.

A memory sub-system 103 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can include a host system 102 that is coupled to one or more memory sub-systems 103. In some embodiments, the host system 102 is coupled to different types of memory sub-systems 103. FIG. 1 illustrates one example of a host system 102 coupled to one memory sub-system 103. The host system 102 uses the memory sub-system 103, for example, to write data to the memory sub-system 103 and read data from the memory sub-system 103. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. The host system 102 can include a traffic generator 105 and a host memory controller 106. The traffic generator 105 can include a processor chipset (e.g., CPU chipset) and a software stack executed by the processor chipset. The processor chipset can include one or more cores and/or one or more caches. The traffic generator 105 can further include a buffer (e.g., also referred to as a host buffer) that initially stores host commands received at the host system 102.

The host memory controller 106 can operate as a storage protocol controller (e.g., PCIe controller, SATA controller, CXL controller). The host memory controller 106 can include a command component 113 (e.g., coupled to) and a command queue 114. Although not shown in FIG. 1 so as to not obfuscate the drawings, the command component 113 can include various circuitry to facilitate performance of operations described herein. For example, the command component 113 can operate in an active manner to inquire into host commands stored in a buffer of the traffic generator 105 and flexibly switch among various policies in determining which one to retrieve by and to the host memory controller 106. For example, in one example, the command component 113 can be configured to retrieve host commands (regardless of whether they are of a write or a read command) from the host buffer in a sequence they are stored in the host buffer. In another example, the command component 113 can be configured to prevent host commands of a particular type (e.g., write command) from being retrieved from the host buffer (and inserted into the command queue 114) and search for host commands of a different type (e.g., read command) to insert those host commands of the different type only to the command queue 114. The command component 113 can switch between these two policies based on a quantity of host commands of a respective type enqueued in the command queue 114. For example, when it is determined that a quantity of write commands enqueued in the command queue 114 has met a criterion (e.g., reached a threshold quantity), the command component 113 that has operated the command queue 114 to retrieve host commands in a sequence they were stored in the host buffer can be configured to switch its policy to operate the command queue 114 to prevent retrieving write commands from the host buffer and retrieve read commands only. Operating the command queue 114 in this manner described above can ensure at least a particular number of slots within the command queue 114 to be reserved for host commands of a particular type (e.g., read commands).

Host commands enqueued in the command queue 114 can be further issued to the memory sub-system 103 according to various policies. In one example, the command component 113 can be configured to operate the command queue 114 according to FIFO policy such that host commands enqueued in the command queue 114 can be issued in an order they were inserted into the command queue 114. In another example, the command component 113 can be configured to operate the command queue 114 to provide host commands of a particular type (e.g., read commands) priority over those host commands of a different type (e.g., write commands), which can cause more host commands of the particular type to be executed (e.g., at the memory sub-system 103) than if the command queue 114 had been operated according to the FIFO policy. As described further herein, the command component 113 can switch between those policies in issuing host commands from the command queue 114 to the memory sub-system 103 based on availability/capacity of the memory sub-system 103 (e.g., whether resources of the memory sub-system 103 are available to receive/execute host commands of the particular type).

In some embodiments, the command component 113 can include special purpose circuitry in the form of an ASIC, FPGA, state machine, and/or other logic circuitry that can allow the command component 113 to orchestrate and/or perform operations to retrieve host commands from the traffic generator 105 and/or issue the host commands to the memory sub-system 103 according to various policies and/or switch between those policies described herein.

The host system 102 can be coupled to the memory sub-system 103 via a physical host interface (e.g., located on the host memory controller 106). Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 102 and the memory sub-system 103. The host system 102 can further utilize an NVM Express (NVMe) interface to access components (e.g., memory devices 115) when the memory sub-system 103 is coupled with the host system 102 by the PCIe interface. The physical host interface can provide an interface for passing control, address, data, and other signals between the memory sub-system 103 and the host system 102. FIG. 1 illustrates a memory sub-system 103 as an example. In general, the host system 102 can access multiple memory sub-systems via a same communication connection, multiple separate communication connections, and/or a combination of communication connections.

In some embodiments, the host memory controller 106 can be a Compute Express Link (CXL) compliant controller coupled to the memory sub-system 103 via a CXL link that operates according to PCIe/CXL protocol. CXL is a high-speed central processing unit (CPU)-to-device and CPU-to-memory interconnect designed to accelerate next-generation data center performance. CXL technology maintains memory coherency between the CPU memory space and memory on attached devices, which allows resource sharing for higher performance, reduced software stack complexity, and lower overall system cost. CXL is designed to be an industry open standard interface for high-speed communications, as accelerators are increasingly used to complement CPUs in support of emerging applications such as artificial intelligence and machine learning. CXL technology is built on the PCIe infrastructure, leveraging PCIe physical and electrical interfaces to provide advanced protocol in areas such as input/output (I/O) protocol, memory protocol (e.g., initially allowing a host to share memory with an accelerator), and coherency interface.

The memory devices 115, 116 can include any combination of the different types of non-volatile memory devices and/or volatile memory devices. The volatile memory devices (e.g., memory device 116) can be, but are not limited to, random access memory (RAM), such as dynamic random-access memory (DRAM) and synchronous dynamic random access memory (SDRAM). In a number of embodiments, the memory devices 115, 116 can be a same type of memory devices. For example, the memory devices 115, 116 can both be DRAM devices (e.g., when the sub-system 103 is a DRAM memory module).

Some examples of non-volatile memory devices (e.g., memory device 115) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array.

The memory device 115 can be based on various other types of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

In some embodiments, the memory device 115 can be a FeRAM memory device 115 and the memory device 116 can be a DRAM memory device. In this example, the memory sub-system controller 104 can manage a ferroelectric memory device 115 and a DRAM memory device 116. Further, in some embodiments, instead of managing both a FeRAM memory device 115 and a DRAM memory device 116 and a, the memory controller 104 can be configured to manage either just FeRAM memory devices 115 or just DRAM memory devices 116.

The memory sub-system controller 104 (or controller 104 for simplicity) can communicate with the memory devices 115, 116 to perform operations such as reading data, writing data, or erasing data at the memory devices 115, 116 and other such operations. The memory sub-system controller 104 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 104 can be a microcontroller, special purpose logic circuitry (e.g., a field programmable gate array (FPGA), an application specific integrated circuit (ASIC), etc.), or other suitable processor.

The memory sub-system controller 104 can include a processor 107 (e.g., a processing device) configured to execute instructions stored in a local memory 108. In the illustrated example, the local memory 108 of the memory sub-system controller 104 includes an embedded memory configured to store instructions for performing various processes, operations, logic flows, and routines that control operation of the memory sub-system 103, including handling communications between the memory sub-system 103 and the host system 102.

In some embodiments, the local memory 108 can include memory registers storing memory pointers, fetched data, etc. The local memory 108 can also include read-only memory (ROM) for storing micro-code. While the example memory sub-system 103 in FIG. 1 has been illustrated as including the memory sub-system controller 104, in another embodiment of the present disclosure, a memory sub-system 103 does not include a memory sub-system controller 104, and can instead rely upon external control (e.g., provided by an external host, or by a processor or controller separate from the memory sub-system).

The memory sub-system controller 104 can further include one or more buffers (such as a buffer 109) that are respectively configured to store host commands received from the host memory controller 106, responses (e.g., corresponding to the host commands) to be provided back to the host system 102 and/or host memory controller 106, and/or data associated with the host commands (e.g., data corresponding to a write command and to be written to or data corresponding to a read command and to be read from the memory devices 115 and/or 116). The memory sub-system controller 104 can communicate with the host memory controller 106 as to availability/capacity of the respective buffers and the host memory controller 106 can determine what host commands to issue to the memory sub-system 103 based on the communicated availability/capacity of the buffers, as further described herein.

In general, the memory sub-system controller 104 can receive commands or operations from the host system 102 and can convert the commands or operations into instructions or appropriate commands to achieve the desired access to the memory device 115 and/or the memory device 116. In some embodiments, the memory sub-system controller 104 can include an interface (e.g., at a front end of the memory sub-system controller 104) that includes a flexible bus interconnect and use CXL protocol layers (including CXL.io, CXL.mem, and CXL.cache) to couple the memory sub-system controller 104 to the host system 102, such as the host memory controller 106 that is a CXL compliant controller.

The memory sub-system controller 104 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 115. The memory sub-system controller 104 can further include host interface circuitry to communicate with the host system 102 via the physical host interface. The host interface circuitry can convert the commands received from the host system into command instructions to access the memory device 115 and/or the memory device 116 as well as convert responses associated with the memory device 115 and/or the memory device 116 into information for the host system 102.

The memory sub-system 103 can also include additional circuitry or components that are not illustrated. In some embodiments, the memory sub-system 103 can include a cache or buffer (e.g., DRAM) and address circuitry (e.g., a row decoder and a column decoder) that can receive an address from the memory sub-system controller 104 and decode the address to access the memory device 115 and/or the memory device 116.

In some embodiments, the memory device 115 can include a local media controller 110 that operates in conjunction with memory sub-system controller 104 to execute operations on one or more memory cells of the memory devices 115. An external controller (e.g., memory sub-system controller 104) can externally manage the memory device 115 (e.g., perform media management operations on the memory device 115). In some embodiments, a memory device 115 is a managed memory device, which is a raw memory device combined with a local controller (e.g., local media controller 110) for media management within the same memory device package. An example of a managed memory device is a managed NAND (MNAND) device.

In a non-limiting example, a system (e.g., the computing system 100) can include a host memory controller comprising a command queue (e.g., the command queue 114). The command queue can be configured to accommodate a particular total quantity of host commands comprising host commands of a first type and of a second type. The host memory controller can be further configured to receive a sequence of host commands to be inserted into the command queue, each one of the host commands being of the first type or of the second type command queue. The host memory controller can be further configured to, responsive to determining that a current quantity of host commands of the first type in the command queue has met a criterion, prevent a subsequent host command of the first type from being inserted into the command queue even if the current quantity of host commands in the command queue is less than the total quantity. The host memory controller can be further configured to search for a subsequent host command of the second type in the sequence to insert into the command queue. In some embodiments, the host memory controller is a compute express link (CXL)-compliant memory device coupled to a CXL controller of a memory sub-system via a CXL link.

In some embodiments, a host command of the first type can correspond to a write command and a host command of the second type can correspond to a read command. In some embodiments, the host memory controller can be configured to sequentially search, to provide a host command of the second command queue priority over a host command of the first type, for a host command of the second type among host commands enqueued in the command queue. In this example, the host memory controller can be further configured to issue, to a memory sub-system, the host command of the second type prior to issuance of the other host commands of the first type and enqueued in the command queue.

In another non-limiting example, a system (e.g., the computing system 100) can include a host memory controller comprising a command queue (e.g., the command queue 114). The command queue can be configured to accommodate a particular total quantity of host commands comprising host commands of a first type and of a second type. The host memory controller can be configured to insert a sequence of host commands into the command queue regardless of a respective type of each host command of the sequence until a quantity of host commands of a first type and stored in the command queue is determined to have met a criterion. The host memory controller can be further configured to search a subsequent host command of a second type among those host commands enqueued in the command queue to issue the subsequent host command prior to the other host commands of the first type and enqueued in the command queue.

In some embodiments, the host memory controller can be configured to group a plurality of host commands as a packet (e.g., a flow control unit (FLIT)) prior to issuing the plurality of host commands. In this example, the host memory controller can be configured to issue the packet to a memory sub-system to cause the memory sub-system to execute each host command of the packet.

In some embodiments, the host memory controller can be configured to issue, to a memory sub-system, the subsequent host command of the second type prior to the other host commands of the first type and enqueued in the command queue in response to a buffer of the memory sub-system being available to receive the subsequent host command or data corresponding to the subsequent host command, or both. In some embodiments, a host command of the first type can correspond to a write command and a host command of the second type can correspond to a read command.

In some embodiments, the host memory controller can be configured to issue the subsequent host command to a memory sub-system according to a compute express link (CXL) protocol. In some embodiments, the host memory controller can be configured to prevent a write command from being inserted into the command queue in response to a quantity of host commands stored in the command queue and corresponding to a write command having met the criterion.

In some embodiments, the host memory controller can be configured to, in response to a quantity of host commands stored in the command queue and corresponding to a write command having met the criterion, search a subsequent read command among host commands of the sequence. In this example, the host memory controller can be configured to insert the subsequent read command into the command queue.

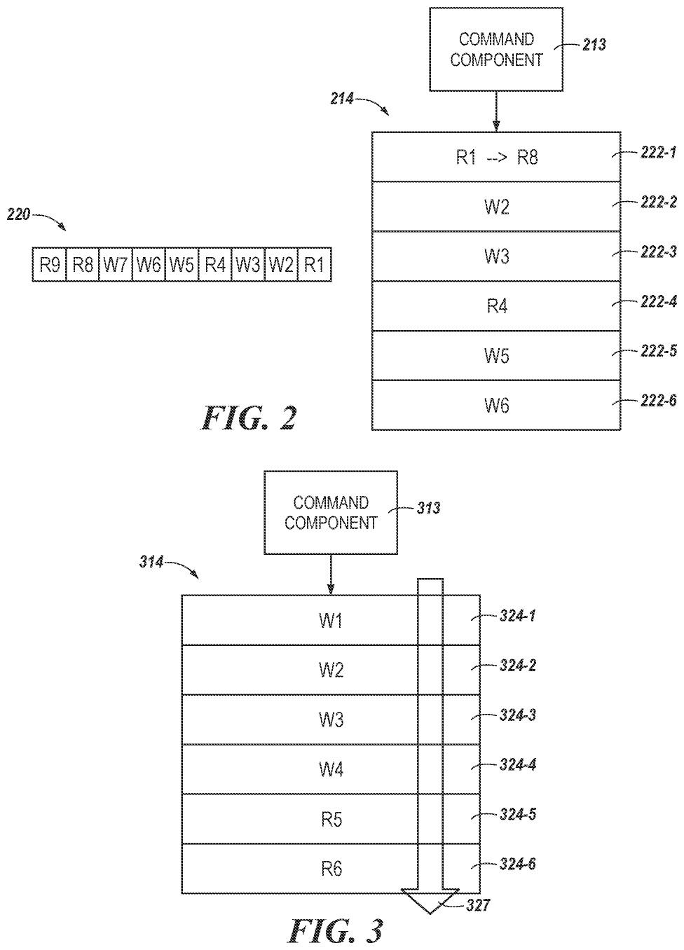

FIG. 2 illustrates an example of operating a command queue 214 in accordance with some embodiments of the present disclosure. A command component 213 and a command queue 214 can be analogous to the command component 113 and command queue 114 illustrated in FIG. 1, herein. Although the command queue 214 is illustrated be capable of storing up to six host commands (e.g., in six slots 222-1, . . . , 222-6 (collectively referred to as slots 222) as illustrated in FIG. 2), embodiments are not so limited to a particular total quantity of host commands storable in a command queue (e.g., the command queue 214).

The command component 213 can be configured to operate the command queue 214 to fill empty slots 222 with at least a portion of a sequence of host commands 220 illustrated in FIG. 2. The sequence 220 includes nine host commands including four read commands (e.g., R1, R4, R8, and R9) and five write commands (W2, W3, W5, W6, and W7) in an order of host commands R1, W2, W3, R4, W5, W6, W7, R8, and R9.

Prior to a quantity of write commands enqueued (e.g., stored) in the command queue 214 having met a criterion (e.g., reached a threshold quantity), host commands of the sequence 220 can be sequentially retrieved to and inserted into the command queue 214 (e.g., empty command queue). For example, if the threshold quantity is assumed to be four, the command component 213 can be configured retrieve the first six host commands (e.g., R1, W2, W3, R4, and W5) from the sequence 220 and insert those into slots 222-1 to 222-6 of the command queue 214. In this example, therefore, the slot 222-1 stores a read command R1, the slot 222-2 stores a write command W2, the slot 222-3 stores a write command W3, the slot 222-4 stores a read command R4, the slot 222-5 stores a write command W5, and the slot 222-6 stores a write command W6, which result in two read commands and four write commands in the command queue 214.

If the read command W1 is assumed to have been issued from the command queue 214 (e.g., to the memory sub-system 103 illustrated in FIG. 1), the command queue 214 becomes available to receive an additional host command. In this example, which host command to retrieve from the sequence 220 can be determined based on whether a criterion has been met (e.g., a threshold quantity has been reached) for a quantity of write commands. Turning back to the example in which the threshold quantity was assumed to be four, a subsequent host command retrieved from the sequence 220 can be a read command since a quantity of write commands (e.g., writes commands W2, W3, W5, and W6) in the command queue 214 has already reached the threshold quantity of four. Therefore, a subsequent read command of the sequence 220, which is a read command R8, can be retrieved from the sequence 220 and inserted into the command queue 214 as illustrated in the slot 222-1 of FIG. 2.

FIG. 3 illustrates another example of operating of a command queue 314 in accordance with some embodiments of the present disclosure. A command component 313 and a command queue 314 can be analogous to the command component 113 and command queue 114 illustrated in FIG. 1, herein. Although the command queue 314 is illustrated be capable of storing up to six host commands (e.g., in 6 slots 324-1, . . . , 324-6 (collectively referred to as slots 324) as illustrated in FIG. 2), embodiments are not so limited to a particular total quantity of host commands a command queue (e.g., the command queue 314) can store. That is, the command queue 314 is not limited to a particular size or depth.

As illustrated in FIG. 3, those 6 slots 324-1, . . . , 324-6 (collectively referred to as slots 324) of the command queue 314 are already filled with (e.g., store) a write command W1, a write command W2, a write command W3, a write command W4, a read command R5, and a read command R6, respectively. A numerical value subsequent to “W” or “R” illustrated in FIG. 3 can represent an order in which host commands were inserted into the command queue 314. In the example illustrated in FIG. 3, for example, host commands were inserted into the command queue 314 in an order of W1, W2, W3, W4, R5, and R6.

In issuing host commands to the memory sub-system, in one example, the command component 313 can provide a read command priority over a write command such that a subsequent host command to be issued to the memory sub-system can be searched among read commands firstly. For example, in the example illustrated in FIG. 3, when a read command is provided the priority, a subsequent read command R5 can be issued prior to the write commands W1, W2, W3, and W4 despite that the write commands W1, W2, W3, and W4 were inserted into the command queue 314 prior to the read command R5. In another example, the command component 313 can operate the command queue 314 according to the FIFO policy such that host commands stored in the command queue 314 illustrated in FIG. 3 can be issued in a sequence (e.g., in an order of W1, W2, W3, W4, R5, and R6) indicated by an arrow 327 without providing priority to a read command over a write command.

Whether to provide a read command priority over a write command(s) can be determined based on availability/capacity of the memory sub-system. As described herein, the memory sub-system can include a number of buffers (e.g., the buffer 109 illustrated in FIG. 1) that are respectively configured to store host commands received from the host memory controller 106, responses (e.g., corresponding to the host commands) to be provided back to the host system 102 and/or host memory controller 106, and/or data associated with the host commands (e.g., data corresponding to a write command and to be written to or data corresponding to a read command and to be read from the memory devices 115 and/or 116 illustrated in FIG. 1). If it is determined that the number of buffers are available for a subsequent read command, then the subsequent read command can be provided priority over the other write commands to be issued prior to them. However, if it is determined that the number of buffers are not available for the subsequent read command, the command queue 314 can be operated according to FIFO without provide the subsequent read command priority over the other write commands.

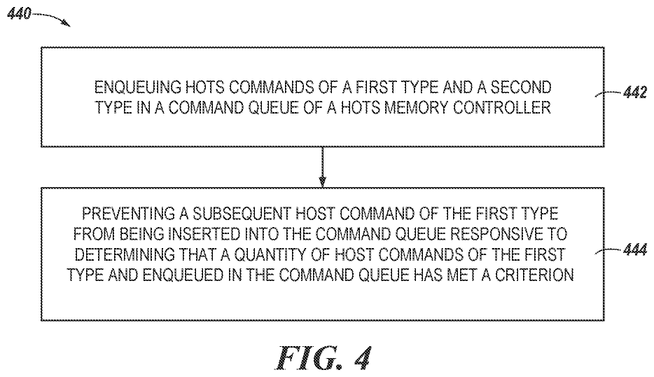

FIG. 4 is a flow diagram corresponding to a method 440 for host command retrieval and issuance policy in accordance with some embodiments of the present disclosure. The method 440 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 440 is performed by the command component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 442, a host command of a first type or a second type can be enqueued in a command queue (e.g., the command queue 114 illustrated in FIG. 1) of a host memory controller (e.g., host memory controller 106 illustrated in FIG. 1). At operation 444, a subsequent host command of the first type can be prevented from being inserted into the command queue responsive to determining that a quantity of host commands of the first type and enqueued in the command queue has met a criterion.

In some embodiments, the host commands enqueued in the command queue of the host memory controller are received from a host processing device where the host commands were stored in a particular sequence (e.g., the traffic generator 105 illustrated in FIG. 1). In one example, the host commands are enqueued in the command queue in the particular sequence they were stored in the host processing device responsive to determining that the quantity of host commands of the first type enqueued in the command queue has not met the criterion. In another example, subsequent to preventing the subsequent host command of the first type from being inserted into the command queue, a subsequent host command of the second type can be searched for among host commands of the particular sequence and the subsequent host command of the second type can be enqueued in the command queue.

In some embodiments, among those host commands enqueued in the command queue, a first host command of the second type can be provided priority over a host command of the first type in further issuing the host commands enqueued in the command queue to a memory sub-system (e.g., the memory sub-system illustrated in FIG. 1). The host command of the second type can be provided priority over the host command of the first type in response to the memory sub-system being available to receive (and execute) the host command of the second type. In response to the memory sub-system not being available to receive (and execute) the host command of the second type, the host commands enqueued in the command queue can be sequentially issued regardless of a respective type of each one of the host commands without providing the host command of the second type priority over the host command of the first type.

In some embodiments, a quantity of host commands enqueued in the command queue can be grouped as a packet (e.g., FLIT). The packet can be issued to a memory sub-system to cause the memory sub-system to execute each host command of the packet. In some embodiments, the host memory controller can be a compute express link (CXL) controller and at least one of host commands enqueued in the command queue can be issued to a memory sub-system according to a CXL protocol, with the packet being a CXL FLIT.

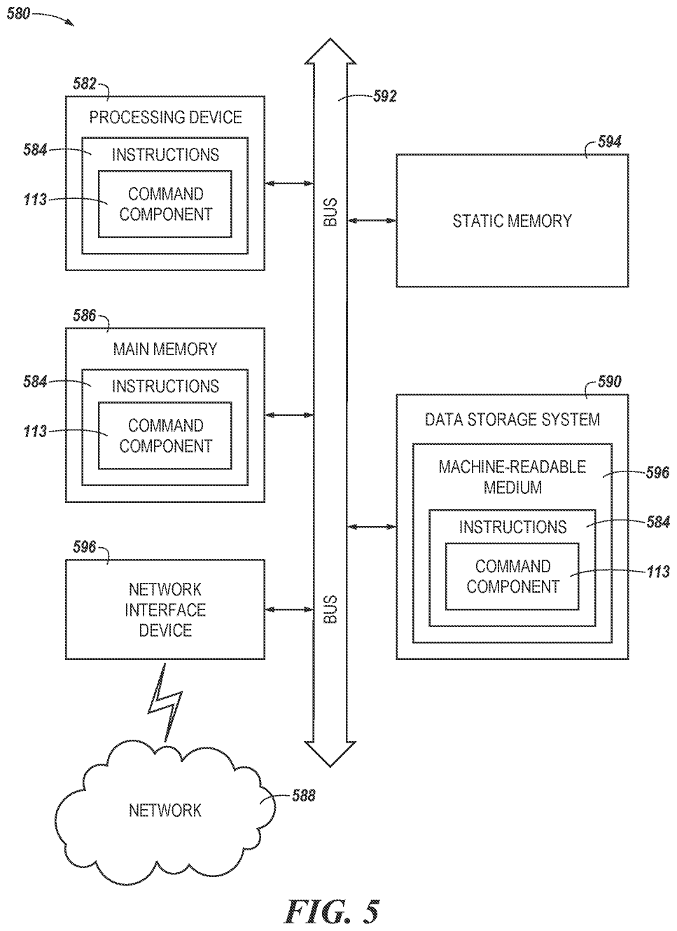

FIG. 5 is a block diagram of an example computer system 580 in which embodiments of the present disclosure may operate. For example, FIG. 5 illustrates an example machine of a computer system 580 within which a set of instructions, for causing the machine to perform any one or more of the methodologies discussed herein, can be executed. In some embodiments, the computer system 580 can correspond to a host system (e.g., the host system 102 of FIG. 1) that includes, is coupled to, or utilizes a memory sub-system (e.g., the memory sub-system 103 of FIG. 1) or can be used to perform the operations of a controller (e.g., to execute an operating system to perform operations corresponding to the command component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 580 includes a processing device 582, a main memory 586 (e.g., read-only memory (ROM), flash memory, dynamic random access memory (DRAM) such as synchronous DRAM (SDRAM) or Rambus DRAM (RDRAM), etc.), a static memory 594 (e.g., flash memory, static random access memory (SRAM), etc.), and a data storage system 590, which communicate with each other via a bus 592.

The processing device 582 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 582 can also be one or more special-purpose processing devices such as an application specific integrated circuit (ASIC), a field programmable gate array (FPGA), a digital signal processor (DSP), network processor, or the like. The processing device 582 is configured to execute instructions 584 for performing the operations and steps discussed herein. The computer system 580 can further include a network interface device 596 to communicate over the network 588.

The data storage system 590 can include a machine-readable storage medium 596 (also known as a computer-readable medium) on which is stored one or more sets of instructions 584 or software embodying any one or more of the methodologies or functions described herein. The instructions 584 can also reside, completely or at least partially, within the main memory 586 and/or within the processing device 582 during execution thereof by the computer system 580, the main memory 586 and the processing device 582 also constituting machine-readable storage media. The machine-readable storage medium 596, data storage system 590, and/or main memory 586 can correspond to the memory sub-system 103 of FIG. 1.

In one embodiment, the instructions 584 include instructions to implement functionality corresponding to a superblock construction component (e.g., the command component 113 of FIG. 1). While the machine-readable storage medium 596 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
enqueuing host commands of a first type and a second type in a command queue of a host memory controller; and
preventing a subsequent host command of the first type from being inserted into the command queue responsive to determining that a quantity of host commands of the first type enqueued in the command queue has met a criterion.

2. The method of claim 1, further comprising providing, among those host commands enqueued in the command queue, a host command of the second type priority over a host command of the first type in further issuing the host commands enqueued in the command queue to a memory sub-system.

3. The method of claim 2, further comprising providing the host command of the second type priority over the host command of the first type in response to the memory sub-system being available to receive the host command of the second type.

4. The method of claim 2, further comprising sequentially issuing, in response to the memory sub-system not being available to receive the host command of the second type, the host commands enqueued in the command queue regardless of a respective type of each one of the host commands without providing the host command of the second type priority over the host command of the first type.

5. The method of claim 1, wherein the host memory controller is a compute express link (CXL) controller, and wherein the method further comprises issuing at least one of host commands enqueued in the command queue to a memory sub-system according to a compute express link (CXL) protocol.

6. The method of claim 1, wherein the host commands enqueued in the command queue of the host memory controller are received from a host processing device where the host commands were stored in a particular sequence.

7. The method of claim 6, wherein enqueueing the host commands of the first type and the second type in the command queue of the host memory controller further comprises enqueuing the host commands in the command queue in the particular sequence they were stored in the host processing device responsive to determining that the quantity of host commands of the first type enqueued in the command queue has not met the criterion.

8. The method of claim 6, further comprising, subsequent to preventing the subsequent host command of the first type from being inserted into the command queue:
searching for a subsequent host command of the second type among host commands of the particular sequence; and
enqueueing the subsequent host command of the second type in the command queue.

9. The method of claim 1, further comprising:
grouping a quantity of host commands enqueued in the command queue as a flow control unit (FLIT); and
issuing the FLIT to a memory sub-system to cause the memory sub-system to execute each host command of the FLIT.

10. A system, comprising:
a host memory controller comprising a command queue, wherein the command queue is configured to accommodate a particular total quantity of host commands comprising host commands of a first type and of a second type; and
wherein the host memory controller is further configured to:
receive a sequence of host commands to be inserted into the command queue, each one of the host commands being of the first type or of the second type command queue;
responsive to determining that a current quantity of host commands of the first type in the command queue has met a criterion, prevent a subsequent host command of the first type from being inserted into the command queue even if the current quantity of host commands in the command queue is less than the total quantity; and
search for a subsequent host command of the second type in the sequence to insert into the command queue.

11. The system of claim 10, wherein the host memory controller is configured to:
sequentially search, to provide a host command of the second command queue priority over a host command of the first type, for a host command of the second type among host commands enqueued in the command queue; and
issue, to a memory sub-system, the host command of the second type prior to issuance of the other host commands of the first type and enqueued in the command queue.

12. The system of claim 10, wherein the host memory controller is a compute express link (CXL)-compliant controller coupled to a CXL controller of a memory sub-system via a CXL link.

13. The system of claim 10, wherein the criterion corresponds to a threshold quantity and the host memory controller is configured to prevent the subsequent host command of the first type from being inserted into the command queue responsive to determining that the current quantity of host commands of the first type in the command queue has reached the threshold quantity.

14. A system, comprising:
a host memory controller comprising a command queue, wherein the command queue is configured to accommodate a particular total quantity of host commands comprising host commands of a first type and of a second type; and
wherein the host memory controller is further configured to:
insert a sequence of host commands into the command queue regardless of a respective type of each host command of the sequence until a quantity of host commands of the first type and stored in the command queue is determined to have met a criterion; and
search a subsequent host command of the second type among those host commands enqueued in the command queue to issue the subsequent host command prior to the other host commands of the first type and enqueued in the command queue.

15. The system of claim 14, wherein the host memory controller is further configured to:
group a plurality of host commands as a packet prior to issuing the plurality of host commands; and
issue the packet to a memory sub-system to cause the memory sub-system to execute each host command of the packet.

16. The system of claim 14, wherein the host memory controller is configured to issue, to a memory sub-system, the subsequent host command of the second type prior to the other host commands of the first type and enqueued in the command queue in response to a buffer of the memory sub-system being available to receive the subsequent host command or data corresponding to the subsequent host command, or both.

17. The system of claim 14, wherein:
a host command of the first type corresponds to a write command; and
a host command of the second type corresponds to a read command.

18. The system of claim 17, wherein the host memory controller is configured to prevent a write command from being inserted into the command queue in response to a quantity of host commands stored in the command queue and corresponding to a write command having met the criterion.

19. The system of claim 17, wherein the host memory controller is configured to, in response to a quantity of host commands stored in the command queue and corresponding to a write command having met the criterion:
search a subsequent read command among host commands of the sequence; and
insert the subsequent read command into the command queue.

20. The system of claim 14, wherein the host memory controller is configured to issue the subsequent host command to a memory sub-system according to a compute express link (CXL) protocol.
